(19) United States
(12) Patent Application Publication
(10) Pub. No.: US 2009/0181754 A1
(43) Pub. Date: Jul. 16, 2009

(54) GAMING SYSTEM AND A METHOD OF GAMING

(75) Inventor: Gregory Leigh Plowman, Alexandria (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, Lane Cove (AU)

(21) Appl. No.: 12/196,861

(22) Filed: Aug. 22, 2008

(30) Foreign Application Priority Data
Aug. 24, 2007 (AU) 2007904602

(51) Int. Cl. A63F 9/24; A63F 13/00

(52) U.S. Cl. 463/20; 463/31

(57) ABSTRACT

A gaming system is disclosed which includes a display including a plurality of standard display positions and at least one additional display position. Each standard display position includes at least one visible standard symbol and each additional display position includes at least one visible additional symbol. An additional position selector is arranged to facilitate selection by a player of at least one additional display position. Selection of an additional display position causes an additional symbol displayed at the additional display position to be emphasized relative to when the additional display position is not selected. A symbol selector is arranged to select symbols for display at the standard display positions and at the at least one additional display position. An outcome generator is arranged to determine a game outcome based on symbols displayed at the standard display positions and the or each additional symbol displayed at any selected additional symbol position.

### CROSS-REFERENCE TO RELATED APPLICATIONS

The present application claims the benefit of priority to Australian Provisional Patent Application No. 2007904602, filed on Aug. 24, 2007, entitled “A Gaming System and a Method of Gaming”, which is herein incorporated by reference in its entirety.

### FIELD OF THE INVENTION

The present invention relates to a gaming system and to a method of gaming.

### BACKGROUND OF THE INVENTION

It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### SUMMARY OF THE INVENTION

In accordance with a first aspect of the present invention, there is provided a gaming system including:

a display including a plurality of standard display positions and at least one additional display position, each standard display position including at least one visible standard symbol and each additional display position including at least one visible additional symbol;

a position selector arranged to facilitate selection by a player of at least one additional display position, wherein selection of an additional display position causes an additional symbol displayed at the additional display position to be emphasized relative to when the additional display position is not selected;

a symbol selector arranged to select symbols for display at the standard display positions and at the at least one additional display position; and

an outcome generator arranged to determine a game outcome based on symbols displayed at the standard display positions and the or each additional symbol displayed at any selected additional symbol position.

In one embodiment, each additional display position is selectable if an additional bet is placed by a player.

In one embodiment, the system is arranged such that the standard display positions define at least one win line used to determine game outcomes, and such that selection of an additional display position increases the number of win lines.

The or each additional display position may be located adjacent the standard display positions, for example above, below or laterally disposed relative to the standard display positions.

The standard symbols may be displayed in a plurality of reels and a corresponding plurality of selectable additional display positions may be provided, with each additional display position being associated with one of the reels. In one arrangement two additional display positions are associated with each of the reels.

The standard symbols and/or the additional symbols may include at least one function symbol having an associated function which may be a wild function, a scatter function, a multiplier function, a repeat win function or a jackpot function.

In one embodiment, the system is arranged such that when a specific additional symbol is displayed at a selected additional display position, a function is imparted to at least one standard symbol. The function may be imparted to at least one standard symbol displayed in one or more reels, to all symbols displayed in one or more reels, or to one or more standard displayed symbols having particular characteristics. In one arrangement, the function is a wild function.

In an alternative arrangement, a function is only imparted to one or more symbols displayed in at least one reel if a specific plurality of symbols are displayed in both the at least one reel and in the additional position.

In one embodiment, the system is arranged such that when a specific additional symbol is displayed at a selected additional display position and at least one standard display position, a trigger condition is satisfied. The trigger condition may cause a feature game to commence, may trigger a win outcome, or may multiply a prize awarded for a winning outcome.

Selected symbols may be emphasised by enlarging selected symbols relative to symbols which have not been selected, by increasing the intensity of selected symbols relative to symbols which have not been selected, by reducing the visibility of symbols which have not been selected relative to selected symbols, by displaying selected symbols in colour and symbols which have not been selected in black and white, or in any other way.

In one arrangement, the system includes a standard position selector arranged to facilitate selection by a player of at least one standard display position, wherein selection of a standard display position causes a standard symbol displayed at the standard display position to be emphasized relative to when the standard display position is not selected, and wherein the outcome generator is arranged to determine a game outcome based on symbols displayed at selected standard display positions and any additional symbol displayed at least one selected additional symbol position.

In one embodiment, the gaming system is arranged to operate in normal game mode and special game mode, and the additional position selector is arranged to facilitate selection by a user of an additional symbol position only when the gaming system operates in special game mode.

The gaming system may be arranged to commence special game mode when a predetermined game outcome occurs, on the basis of a game event occurring during a game such as display of a particular symbol, in response to player input, based on the amount or type of bet placed, or when a special game is purchased by a player.

The display may comprise at least two display elements, the system being arranged such that a first display element is arranged to display the plurality of standard display positions, and such that a second display element is arranged to display the at least one additional display positions

The gaming system may be implemented as a stand alone gaming machine or across a network.

In accordance with a second aspect of the present invention, there is provided a method of gaming including:

displaying at each standard display position of a plurality of standard display positions a visible standard symbol;

displaying at each of at least one additional display position a visible additional symbol;

facilitating selection by a player of at least one additional display position;

emphasizing an additional symbol displayed at a selected additional display position relative to an additional symbol displayed at an additional symbol position which has not been selected;

selecting symbols for display at the standard display positions and at the at least one additional display position; and

determining a game outcome based on symbols displayed at the standard display positions and any additional symbol displayed at least one selected additional symbol position.

In accordance with a third aspect of the present invention, there is provided a computer program arranged when loaded into a computer to instruct the computer to operate in accordance with a gaming system including:

a display including a plurality of standard display positions and at least one additional display position, each standard display position including at least one visible standard symbol and each additional display position including at least one visible additional symbol;

an additional position selector arranged to facilitate selection by a player of at least one additional display position, wherein selection of an additional display position causes an additional symbol displayed at the additional display position to be emphasized relative to when the additional display position is not selected;

a symbol selector arranged to select symbols for display at the standard display positions and at the at least one additional display position; and

an outcome generator arranged to determine a game outcome based on symbols displayed at the standard display positions and the or each additional symbol displayed at any selected additional symbol position.

In accordance with a fourth aspect of the present invention, there is provided a computer readable medium having computer readable program code embodied therein for causing a computer to operate in accordance with a gaming system including:

a display including a plurality of standard display positions and at least one additional display position, each standard display position including at least one visible standard symbol and each additional display position including at least one visible additional symbol;

an additional position selector arranged to facilitate selection by a player of at least one additional display position, wherein selection of an additional display position causes an additional symbol displayed at the additional display position to be emphasized relative to when the additional display position is not selected;

a symbol selector arranged to select symbols for display at the standard display positions and at the at least one additional display position; and

an outcome generator arranged to determine a game outcome based on symbols displayed at the standard display positions and the or each additional symbol displayed at any selected additional symbol position.

In accordance with a fifth aspect of the present invention, there is provided a data signal having computer readable program code embodied therein for causing a computer to operate in accordance with a gaming system including:

a display including a plurality of standard display positions and at least one additional display position, each standard display position including at least one visible standard symbol and each additional display position including at least one visible additional symbol;

an additional position selector arranged to facilitate selection by a player of at least one additional display position, wherein selection of an additional display position causes an additional symbol displayed at the additional display position to be emphasized relative to when the additional display position is not selected;

a symbol selector arranged to select symbols for display at the standard display positions and at the at least one additional display position; and

an outcome generator arranged to determine a game outcome based on symbols displayed at the standard display positions and the or each additional symbol displayed at any selected additional symbol position.

### BRIEF DESCRIPTION OF THE DRAWINGS

Certain embodiments of the present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention;

FIG. 8 is an example display representation of a gaming system in accordance with an embodiment of the present invention when 7 standard display locations have been selected by a player during implementation of a game;

FIG. 9 is an example display representation of the embodiment shown in FIG. 8 when 9 standard display locations have been selected by a player;

FIG. 10 is an example display representation of the embodiment shown in FIGS. 8 and 9 when 15 standard display locations have been selected by a player;

FIG. 11 is an example display representation of the embodiment shown in FIGS. 8 to 10 when 15 standard display locations and 2 additional display locations have been selected by a player;

FIG. 12 is a diagrammatic representation of display positions shown on a display of a gaming system in accordance with an alternative embodiment of the present invention;

FIG. 13 is a diagrammatic representation of display positions of a gaming system in accordance with a further alternative embodiment of the present invention;

FIG. 14 is a diagrammatic representation of display positions of a gaming system in accordance with a further alternative embodiment of the present invention;

FIG. 15 is a diagrammatic representation of display positions of a gaming system in accordance with a further alternative embodiment of the present invention;

FIG. 16 is a diagrammatic representation of display positions of a gaming system in accordance with a further alternative embodiment of the present invention;

FIG. 17 is a diagrammatic representation of display positions of a gaming system in accordance with a further alternative embodiment of the present invention; and

FIG. 18 is a diagrammatic representation of display positions of a gaming system in accordance with a further alternative embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DESCRIPTION OF CERTAIN EMBODIMENTS

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. With some such probabilistic games, the set of symbols include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

The present gaming system operates such that a plurality of standard display positions and at least one additional display position are shown to a player, each standard and additional display position including a visible symbol, and a player is able to select one or more additional display positions that are desired to be used in determining a game outcome. After selection of an additional display position, the additional symbol shown at the selected additional display position is emphasized relative to other additional display positions which have not been selected, if any.

The option for a player to select an additional display position to be used in determining game outcomes may be available for all games or only under special game conditions such as during free games or when a player has placed a specific bet entitling the player to select an additional display position.

In one variation, the option for a player to select an additional display position may always be available and the system 10 arranged such that each additional display position is purchasable by a player and the bet placed by the player increases with each further additional display position selected.

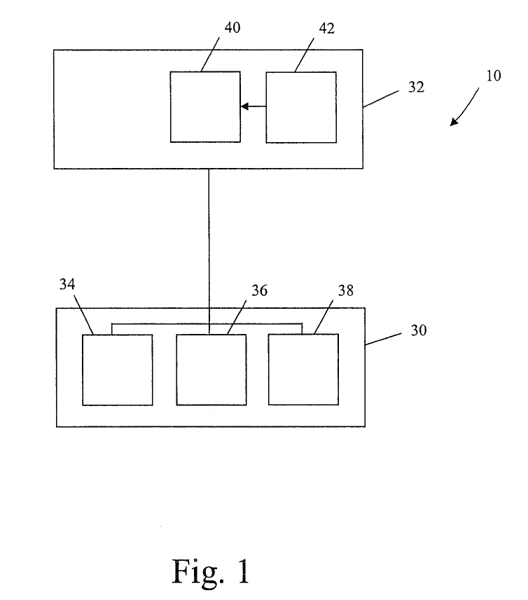

Referring to FIG. 1, a schematic diagram of core components of a gaming system 10 is shown. The core components comprise a player interface 30 and a game controller 32. The player interface 30 is arranged to enable interaction between a player and the gaming system and for this purpose includes input/output components for the player to enter instructions and play the game.

Components of the player interface 30 may vary but will typically include a credit mechanism 34 to enable a player to input credits and receive payouts, one or more displays 36 which may include a touch screen, and a game play mechanism 38 arranged to enable a player to input game playing instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

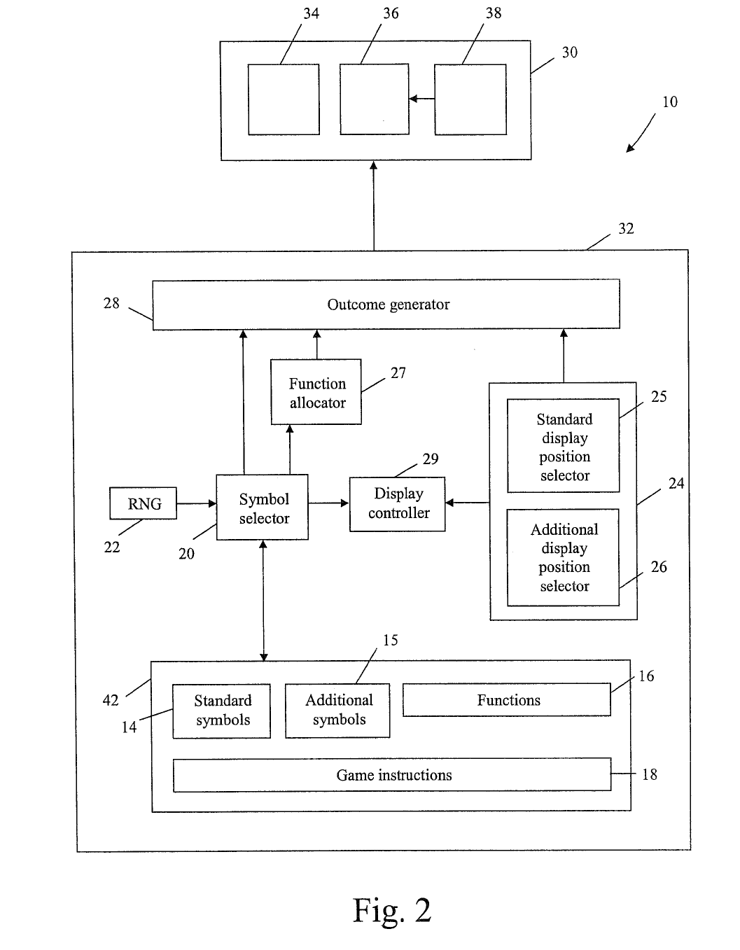

A functional diagram illustrating operative components of the game controller 32 is shown in FIG. 2.

The memory 42 is arranged to store symbols data including standard symbols data 14 indicative of a set of standard symbols for subsequent selection and display to a player at standard display locations, function data 16 and additional symbols data 15 indicative of a set of additional symbols for subsequent selection and display to a player at one or more additional display locations, indicative of one or more functions allocatable to the standard and/or additional symbols, and game instruction data 18 indicative of game instructions usable by the gaming machine 10 to control operation of the game.

The game controller 32 includes a symbol selector 20 which is arranged to select several standard symbols from the available standard symbols 14 for display to a player in a plurality of standard display positions, each standard display position in this example including one standard symbol, and to select at least one additional symbol from the available additional symbols 15 for display to a player in at least one corresponding additional symbol position. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

The game controller 32 also comprises a display position selector 24 arranged to facilitate selection by a player of one or more additional display positions to be used in determining game outcomes, and in this example to also facilitate selection by a player of a plurality of standard display positions to be used in determining game outcomes.

For this purpose, the display 24 includes a standard display position selector 25 usable by a player to select one or more standard display positions to be used in determining game outcomes, and an additional display position selector 26 usable by a player to select one or more additional display positions to be used in determining game outcome. The standard and additional display position selectors 25, 26 may be implemented using a touch screen and suitable programs stored in the memory 42.

The game controller 32 also comprises a function allocator 27 arranged to select and allocate one or more functions to one or more standard and/or additional symbols. Such functions include a wild function, a scatter function, or any other function which may be applied to a symbol or to the game.

The game controller 32 also comprises an outcome generator 28 which in accordance with the game instructions 18 determines game outcomes based on the standard symbols selected for display to the player by the symbol selector 20 and associated with standard symbol positions selected by a player, and on additional symbols selected by the symbol selector 20 and associated with one or more additional display positions selected by the player.

The game controller 32 also comprises a display controller 29 arranged to receive data indicative of standard and additional symbols which have been selected by the symbol selector 20 for display, to receive data indicative of any additional display position which has been selected by a player and in this example the standard display positions which have been selected by a player, and to emphasize symbols shown at selected standard and additional display positions relative to symbols shown at display positions which have not been selected.

It will be understood that the standard display positions, the additional display positions and the standard and additional symbols selected for display at the standard and additional display positions are always visible to a player, and that standard and additional symbols are only taken into account when determining game outcomes when the standard and additional symbols are emphasized on the display.

In the embodiments described below, the symbol selector 20, the display position selector 24, the function allocator 26, the outcome generator 28, and the display controller 29 are at least partly implemented using the processor 40 and associated software, although it will be understood that other implementations are envisaged.

The gaming system 10 can take a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

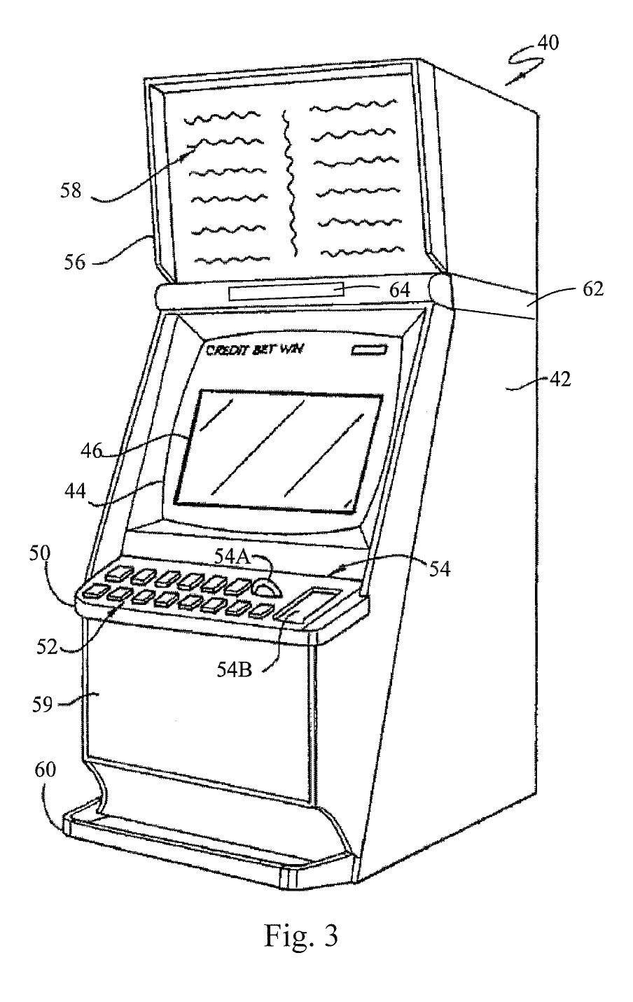

A gaming system in the form of a stand alone gaming machine 40 is illustrated in FIG. 3. The gaming machine 40 includes a console 42 having a display 44 on which is displayed representations of a game 46 that can be played by a player A mid-trim 50 of the gaming machine 40 houses a bank of buttons 52 for enabling a player to interact with the gaming machine, in particular during gameplay. The mid-trim 50 also houses a credit input mechanism 54 which in this example includes a coin input chute 54A and a bill collector 54B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 56 may carry artwork 58, including for example pay tables and details of additional awards and other information or images relating to the game. Further artwork and/or information may be provided on a front panel 59 of the console 42. A coin tray 60 is mounted beneath the front panel 59 for dispensing cash payouts from the gaming machine 30.

The display 44 is in the form of a video display unit, particularly a cathode ray tube screen device. Alternatively, the display 44 may be a liquid crystal display, plasma screen, or any other suitable video display unit. The top box 56 may also include a display, for example a video display unit, which may be of the same type as the display 44, or of a different type. The display 44 may comprise a touch screen usable by a player to interact with the gaming machine, in particular during game play.

The buttons 52 and/or a touch screen incorporated into the display 44 may be used by a player during game play to select one or more additional display position, and in this example to select a plurality of standard display positions which are to be used to determine game outcomes.

The display 44 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

In this example, a single display is used to display the standard and additional display positions. However, it will be understood that other arrangements are possible. For example, a first display element may be provided for displaying the standard display positions and standard symbols, and a second display element may be provided for displaying the additional display positions and additional symbols.

A player marketing module (PMM 62 having a display 64 is connected to the gaming machine 10. The main purpose of the PMM 62 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

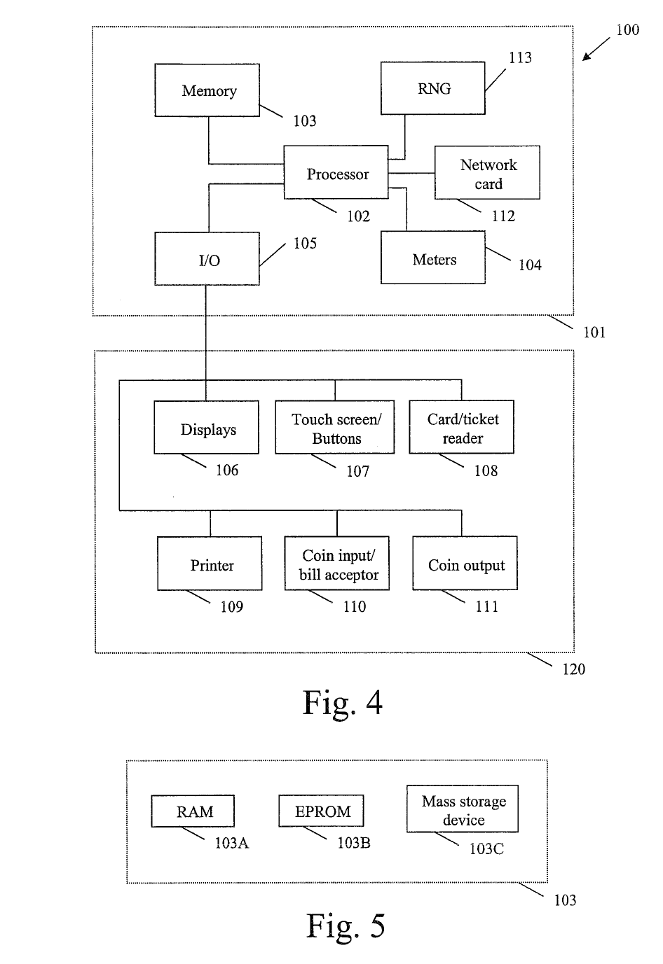

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with certain embodiments of the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted depending upon the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

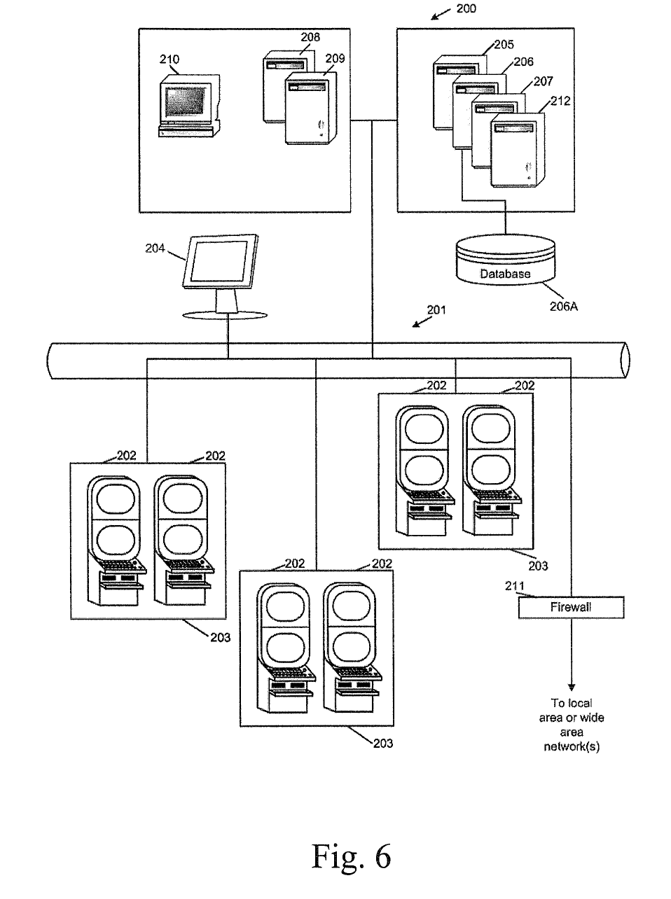

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During operation, the game controller, whether implemented in a stand alone gaming machine 10, 40, 100 or over a network 201, implements a probabilistic game wherein at least during part of the game the gaming system displays to a player a plurality of standard symbols at a plurality of standard display positions and at least one additional symbol of at least one additional display position, and facilitates selection by a player of at least one additional display position which is desired to be used to determine game outcomes.

Examples of specific implementations of the gaming system will now be described in relation to a stand alone gaming machine 10, 40, 100 although it will be understood that implementation may also be carried out using other gaming system architectures such as a network architecture of the type shown in FIG. 6.

In one embodiment selection by a player of an additional display position to be used in determining game outcomes is always available to a player.

In an alternative embodiment, the gaming system is operable in normal game mode and special game mode.

During normal game mode, selection of an additional display position is not available to a player. In an example comprising a plurality of reels with player selectable standard display positions, the reels comprise a plurality of standard symbols. Win outcomes are determined on the basis of the standard symbols appearing at player selected standard display positions when the reels stop rotating.

During special game mode, a player is provided with the option of selecting at least one additional display position to be used in determining game outcomes.

The gaming system may be arranged to commence special game mode when a predetermined game outcome occurs, and special game mode may comprise one or more free games. Special game mode may commence automatically on the basis of a game event occurring during a game such as display of a particular symbol, based on game outcomes determined by the gaming system, or may be prompted by a player pressing a button on the gaming system 10, 40, 100 after the player has identified that a game outcome corresponding to special game mode requirements has occurred.

The gaming system 10, 40, 100 may also be arranged so as to determine eligibility for special game mode, for example based on the amount or type of bet placed, based on certain time periods and so on.

Special game mode may also be arranged to commence when a special game is purchased by a player.

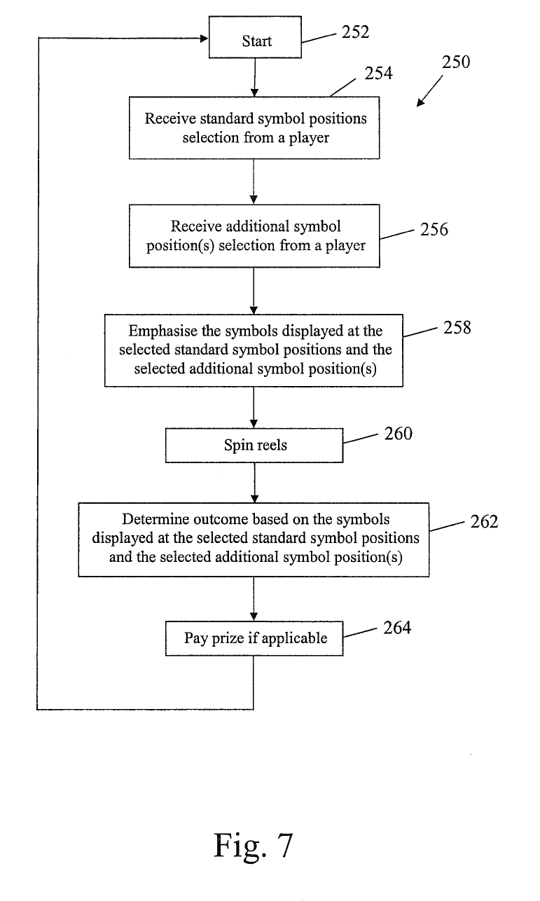

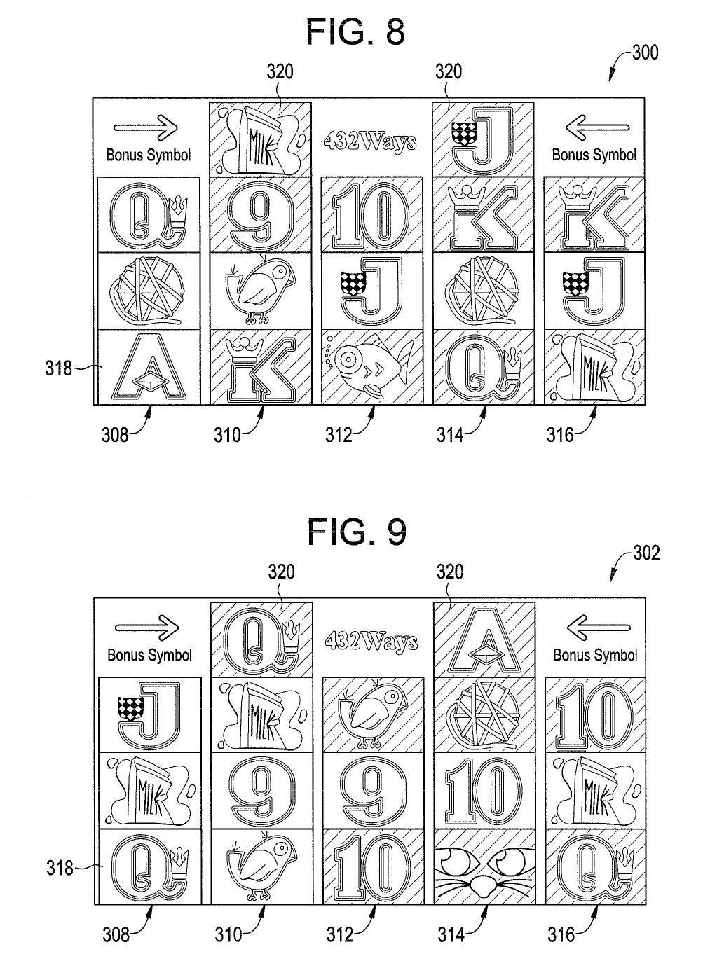

Specific examples will now be described in relation to flow diagram 250 shown in FIG. 7 which illustrates steps 252 to 264 of a method of gaming implemented by the gaming system according to the present embodiment, and in relation to FIGS. 8 to 18.

In a first example, five reels are provided. The reels are virtual reels and, as such, representations of the reels are displayed on a graphical display device 44. Example screen representations 300, 302, 304, 306 shown on the display device 44 are shown in FIGS. 8 to 11.

As shown in FIG. 8, the display representation 300 includes five virtual reels 308, 310, 312, 314, 316, each of which includes three standard display positions 318. Each standard display position 318 is selectable by a player such that when selected the standard symbol associated with the standard display position is emphasized, in this example by increasing the intensity of the standard symbol 318. The selected standard symbol is thereafter taken into account in determining game outcomes.

In this example, each standard display position selected must be purchased by a player such that the bet placed by the player increases with increasing standard display positions selected.

The display representation 300 also includes two additional display positions 320 which in this example form part of second and fourth reels 310, 314 respectively. Each additional display position 320 is selectable by a player such that when selected the additional symbol associated with the additional display position is emphasized, in this example by increasing the intensity of the additional symbol 320. The emphasized additional symbol 320 is thereafter taken into account in determining game outcomes.

In this example, each additional display position selected must be purchased by a player such that the bet placed by the player increases with increasing additional display positions selected.

As shown in FIG. 8, all standard display positions 318 in the first reel 308, and all standard display positions 318 along a centre line have been selected by a player. In this example, the selected standard display positions correspond to three available pay lines. No additional display positions have been selected.

As shown in FIG. 9, all standard display positions 318 in the first and second reels 308, 310, and all standard display positions 318 along a centre line have been selected by a player. In this example, the selected standard display positions correspond to 9 available pay lines. No additional symbol positions 320 have been selected.

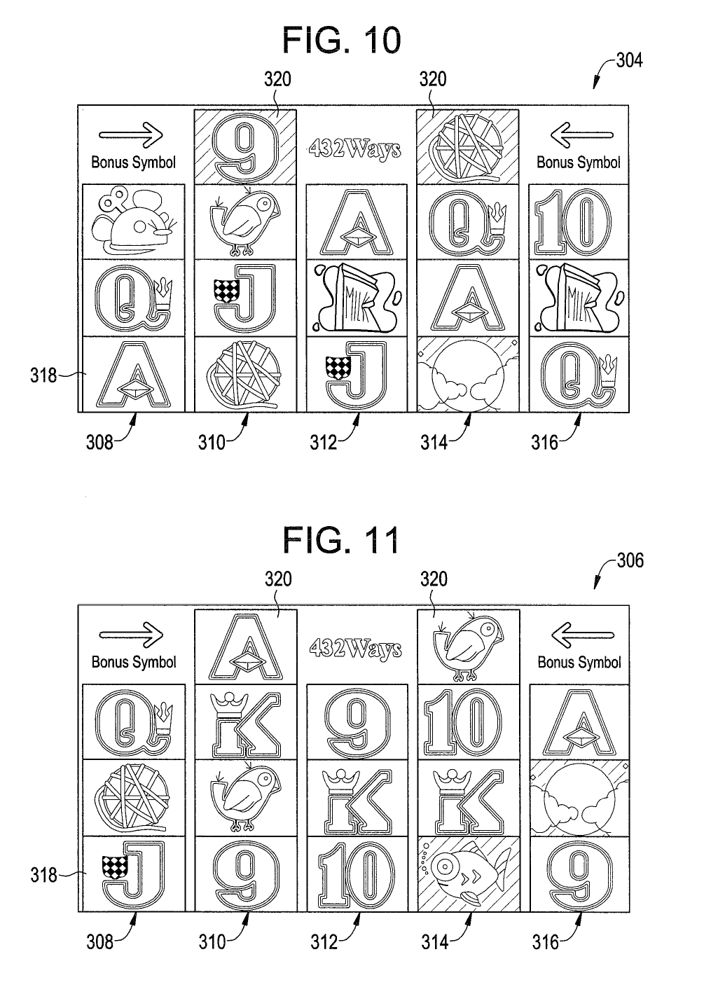

As shown in FIG. 10, all available standard display positions 318 have been selected by a player. In this example, the selected display positions correspond to 243 available pay lines. No additional display positions have been selected.

As shown in FIG. 11, both available additional symbol positions 320 have been selected together with all available standard symbol positions 318. The significance of this in this example is that the additional symbols displayed at the additional symbol positions 320 can form pay lines with symbols in the first, third and fourth reels 308, 312, 316 and, as a consequence, 432 pay lines are available instead of 243 pay lines which are ordinarily available by selection of all standard symbol positions only.

In this example, symbol positions are selected by touching the display at one or more of the standard and additional symbol positions 318, 320. However, other arrangements are envisaged. For example, a user may select the symbol positions using appropriate buttons on a gaming machine 40.

While in the present embodiment, symbols displayed in selected standard and additional positions are emphasized by increasing the intensity of the symbols, it will be understood that other arrangement are possible. For example, symbols displayed in selected standard and additional positions may enlarge relative to the symbols in standard and additional positions which have not been selected, or by representing symbols in standard and additional display positions which have not been selected in black and white whilst maintaining the symbols in selected standard and additional positions in colour, and so on.

After selection of the symbol display positions, the symbol selector 20 selects standard and additional symbols to be displayed in the standard and additional display positions, and the outcome generator 28 evaluates the symbols displayed in the selected standard and additional display positions in order to determine the game outcome. In the event that the symbols displayed in the selected standard and additional display positions corresponds to a win outcome, the player is awarded a prize.

It will be appreciated that in further examples of specific implementations of the gaming system, other standard and additional display position configurations are envisaged.

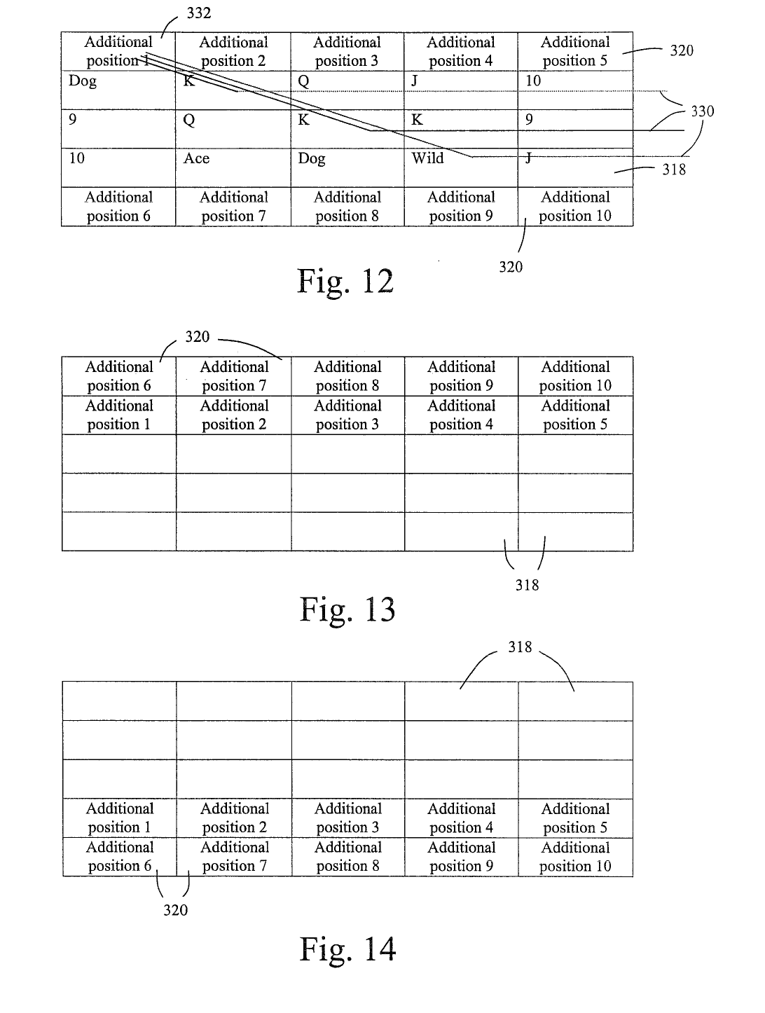

For example, as shown in FIG. 12, 15 centrally located standard display positions 318 may be provided between two horizontally extending lines of additional display positions 320. Example additional pay lines 330 are shown to illustrate the effect of selecting a particular additional position 332 and thereby causing an additional symbol displayed at the additional position 332 to be taken into account when determining game outcome.

In further examples shown in FIGS. 13 and 14, 15 standard display positions are provided with two horizontally disposed lines of additional display positions 320 disposed above or below the standard display positions 318.

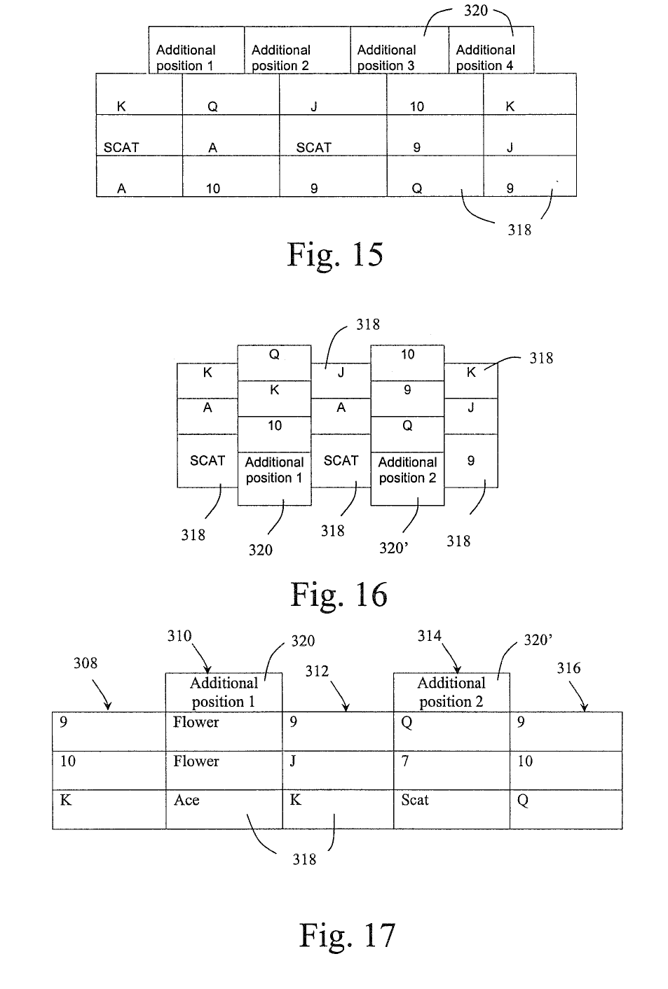

In a further example shown in FIG. 15, 15 standard display positions 318 are provided with four additional display positions 320. However, in this example the additional display positions 320 do not form additional pay lines with the standard symbol positions 318 when selected. Instead, the additional symbol positions 320 may be used to impart a function to the standard symbols or to trigger entitlement to a feature. For example, if a scatter symbol is displayed at an additional display position 320 selected by a player and at least two other scatter symbols are displayed on selected standard display positions, as shown in FIG. 15, the player may be awarded a special game feature.

In a further example shown in FIG. 16, 15 standard display positions 318 and first and second additional display positions 320, 320′ are provided. This example is similar to the example shown in FIG. 15 in that the symbols displayed at the additional display positions 320, 320′ do not form additional lines with standard symbols. With this example, if a special symbol is shown at a selected first additional display position 320, all symbols shown in the corresponding reel become wild. Accordingly, with the present example, if the special symbol appears at the first additional position 320, the player will receive an award for 3 Aces along the centre line.

The example shown in FIG. 17 is similar to the examples shown in FIGS. 15 and 16 in that the symbols displayed at the additional display positions 320, 320′ do not form additional lines with standard symbols. With this example, if three symbols are displayed in the second or fourth reels 310, 314 including at least one of the symbols at an additional display position 320, all symbols in the reel become wild. Accordingly, in the present example, if the first additional position 320 is selected and a flower symbol is displayed, all symbols in the second reel 310 would become wild and the player would receive prizes corresponding to three 9s and three Kings.

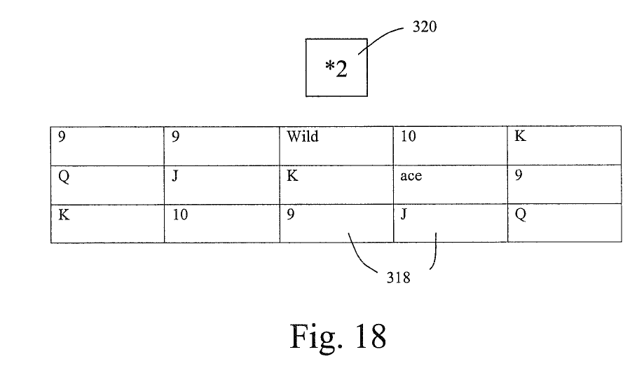

In the example shown in FIG. 18, 15 standard display positions 318 and one additional display position 320 are provided, with the additional display position 320 being disposed separately to the standard display positions 318. In this example, the additional display position 320 may be used to modify the prize payable when a winning game outcome occurs on the standard display positions 318. For example, in the present example display of *2 at the additional display position 320 will cause the prize payable for three 9 symbols to be doubled.

While the above examples are described in relation to a gaming system comprising virtual spinning reels provided with symbols, it will be understood that the invention is applicable to other gaming systems wherein symbols are randomly displayed and the display positions of the symbols has an effect on the game outcome. For example, the invention may be applied to a gaming system arranged to implement a bingo style game.

Modifications and variations as would be apparent to a skilled addressee are deemed to be within the scope of the present invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. As noted above, certain embodiments of the present invention may be implemented using an existing computer processor and/or by a special purpose computer processor incorporated for this or another purpose or by a hardwired system, for example.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A gaming system comprising:
a display comprising a plurality of standard display positions and at least one additional display position, each standard display position including at least one visible standard symbol and each additional display position including at least one visible additional symbol;
an additional position selector arranged to facilitate selection by a player of at least one additional display position, wherein selection of an additional display position causes an additional symbol displayed at the additional display position to be emphasized relative to when the additional display position is not selected;
a symbol selector arranged to select symbols for display at the standard display positions and at the at least one additional display position; and
an outcome generator arranged to determine a game outcome based on symbols displayed at the standard display positions and the or each additional symbol displayed at any selected additional symbol position.

2. A gaming system as claimed in claim 1, wherein each additional display position is selectable if an additional bet is placed by a player.

3. A gaming system as claimed in claim 1, wherein the system is arranged such that the standard display positions define at least one win line used to determine game outcomes, and such that selection of an additional display position increases the number of win lines.

4. A gaming system as claimed in claim 1, wherein the or each additional display position is located adjacent the standard display positions.

5. A gaming system as claimed in claim 4, wherein the or each additional display position is located above, below or laterally relative to the standard display positions.

6. A gaming system as claimed in claim 1, wherein the standard symbols are displayed in a plurality of reels, and the system comprising a corresponding plurality of selectable additional display positions, each additional display position being associated with one of the reels.

7. A gaming system as claimed in claim 1, wherein the standard symbols and/or the additional symbols include at least one function symbol having an associated function.

8. A gaming system as claimed in claim 1, wherein the system is arranged such that when a specific additional symbol is displayed at a selected additional display position, a function is imparted to at least one standard symbol.

9. A gaming system as claimed in claim 8, wherein the function is imparted to at least one standard symbol displayed in one or more reels, to all symbols displayed in one or more reels, or to one or more standard displayed symbols having particular characteristics.

10. A gaming system as claimed in claim 8, wherein the function is a wild function.

11. A gaming system as claimed in claim 8, wherein a function is only imparted to one or more symbols displayed in at least one reel if a specific plurality of symbols are displayed in both the at least one reel and in the additional position.

12. A gaming system as claimed in claim 1, wherein the system is arranged such that when a specific additional symbol is displayed at a selected additional display position and at least one standard display position, a trigger condition is satisfied.

13. A gaming system as claimed in claim 12, wherein the trigger condition causes a feature game to commence, triggers a win outcome, or multiplies a prize awarded for a winning outcome.

14. A gaming system as claimed in claim 1, wherein selected symbols are emphasised by enlarging selected symbols relative to symbols which have not been selected, by increasing the intensity of selected symbols relative to symbols which have not been selected, by reducing the visibility of symbols which have not been selected relative to selected symbols, or by displaying selected symbols in colour and symbols which have not been selected in black and white.

15. A gaming system as claimed in claim 1, wherein the system comprises a standard position selector arranged to facilitate selection by a player of at least one standard display position, wherein selection of a standard display position causes a standard symbol displayed at the standard display position to be emphasized relative to when the standard display position is not selected, and wherein the outcome generator is arranged to determine a game outcome based on symbols displayed at selected standard display positions and any additional symbol displayed at least one selected additional symbol position.

16. A gaming system as claimed in claim 1, wherein the gaming system is arranged to operate in normal game mode and special game mode, and the additional position selector is arranged to facilitate selection by a user of an additional symbol position only when the gaming system operates in special game mode.

17. A gaming system as claimed in claim 16, wherein the gaming system is arranged to commence special game mode when a predetermined game outcome occurs, on the basis of a game event occurring during a game such as display of a particular symbol, in response to player input, based on the amount or type of bet placed, or when a special game is purchased by a player.

18. A gaming system as claimed in claim 1, wherein the display comprises at least two display elements, the system being arranged such that a first display element is arranged to display the plurality of standard display positions, and such that a second display element is arranged to display the at least one additional display positions.

19. A method of gaming comprising:
displaying at each standard display position of a plurality of standard display positions a visible standard symbol;
displaying at each of at least one additional display position a visible additional symbol;
facilitating selection by a player of at least one additional display position;
emphasizing an additional symbol displayed at a selected additional display position relative to an additional symbol displayed at an additional symbol position which has not been selected;
selecting symbols for display at the standard display positions and at the at least one additional display position; and
determining a game outcome based on symbols displayed at the standard display positions and any additional symbol displayed at least one selected additional symbol position.

20. A method as claimed in claim 19, comprising facilitating selection by a player of at least one additional display position if an additional bet is placed by a player.

21. A method as claimed in claim 19, comprising disposing the or each additional display position adjacent the standard display positions.

22. A method as claimed in claim 22, comprising disposing the or each additional display position above, below or laterally relative to the standard display positions.

23. A method as claimed in claim 19, comprising displaying the standard symbols in a plurality of reels, each additional display position being associated with one of the reels.

24. A method as claimed in claim 19, comprising providing at least one function symbol having an associated function.

25. A method as claimed in claim 19, comprising imparting a function to at least one standard symbol when a specific additional symbol is displayed at a selected additional display position.

26. A method as claimed in claim 25, wherein the function is imparted to at least one standard symbol displayed in one or more reels, to all symbols displayed in one or more reels, or to one or more standard displayed symbols having particular characteristics.

27. A method as claimed in claim 25, wherein the function is a wild function.

28. A method as claimed in claim 25, comprising imparting a function to one or more symbols displayed in at least one reel only if a specific plurality of symbols are displayed in both the at least one reel and in the additional position.

29. A method as claimed in claim 19, comprising satisfying a trigger condition when a specific additional symbol is displayed at a selected additional display position and at least one standard display position.

30. A method as claimed in claim 29, comprising causing a feature game to commence, triggering a win outcome, or multiplying a prize awarded for a winning outcome when the trigger condition is satisfied.

31. A method as claimed in claim 19, comprising emphasizing selected symbols by enlarging selected symbols relative to symbols which have not been selected, by increasing the intensity of selected symbols relative to symbols which have not been selected, by reducing the visibility of symbols which have not been selected relative to selected symbols, or by displaying selected symbols in colour and symbols which have not been selected in black and white.

32. A method as claimed in claim 19, comprising facilitating selection by a player of at least one standard display position, emphasizing a standard symbol displayed at a selected standard display position, and determining a game outcome based on symbols displayed at selected standard display positions and any additional symbol displayed at at least one selected additional symbol position.

33. A method as claimed in claim 19, comprising providing normal game mode and special game mode, and facilitating selection by a user of an additional symbol position only during operation in special game mode.

34. A method as claimed in claim 33, comprising commencing special game mode when a predetermined game outcome occurs, on the basis of a game event occurring during a game such as display of a particular symbol, in response to player input, based on the amount or type of bet placed, or when a special game is purchased by a player.

35. A method as claimed in claim 19, comprising providing at least two display elements, displaying the plurality of standard display positions on a first display element, and displaying the at least one additional display positions on a second display element.

36. A computer readable medium having computer readable program code embodied therein for causing a computer to operate in accordance with a gaming system as claimed in claim 1.
